(19) United States
(12) Patent Application Publication
(10) Pub. No.: US 2007/0015847 A1
(43) Pub. Date: Jan. 18, 2007

(54) Red printing ink for color filter applications

(75) Inventors: Lizhong Sun, San Jose, CA (US); Quanyuan Shang, Saratoga, CA (US); John M. White, Hayward, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/182,501

(22) Filed: Jul. 15, 2005

(51) Int. Cl. C03C 17/00

(52) U.S. Cl. 523/160; 427/466

(57) ABSTRACT

Red inks for displays are provided. In one aspect, the red inks include one or more red organic pigments, one or more monomers, one or more polymeric dispersants, and one or more organic solvents. In another aspect, the red inks include one or more red organic pigments, one or more yellow pigments, one or more monomers, one or more oligomers, one or more polymeric dispersants, and one or more organic solvents. Methods of forming displays that include dispensing the red inks by inkjetting onto a substrate and displays that include the red inks are also provided.

### BACKGROUND OF THE INVENTION

1. Field of the Invention

Embodiments of the present invention generally relate to flat panel displays and particularly to compositions and methods for forming color filters for use in flat panel displays.

2. Description of the Related Art

Flat panel displays (FPDs) have become the favored display technology for computers, televisions, and personal electronic devices such as cell phones, personal digital assistants, etc. Liquid crystal displays (LCDs) are a preferred type of commercially available FPDs. Different colors are obtained in liquid crystal displays by transmitting light through a color filter located on a substrate of a LCD. The color filter includes pixels, wherein each pixel may include three colors, typically red, green, and blue. Each color of a pixel may be considered a sub-pixel. Typically, each sub-pixel is surrounded by a black matrix material that provides an opaque area between sub-pixels and therefore prevents light leakage in the thin film transistors (TFTs) of the LCD. FIG. 1 is a top view of two adjacent pixels 1 and 2 of a color filter 10. Pixel 1 includes three sub-pixels 3, 4, and 5, and pixel 2 includes three sub-pixels 6, 7, and 8. Black matrix material 9 surrounds and separates each of the sub-pixels 3, 4, 5, 6, 7, and 8. FIG. 2 is a side, cross-sectional view of color filter 10 showing substrate 12 upon which the black matrix material 9 and the pixels 1 and 2 (shown in FIG. 1) are formed. The sub-pixels 3, 4, and 5 are filled with three different colors of ink, 14, 16, and 18, respectively.

Traditional methods of producing color filters, such as dyeing, lithography, and electrodeposition, require the sequential introduction of the three colors. That is, a first set of pixels having one color is produced by a series of steps, whereupon the process must be repeated twice more to apply all three colors. The series of steps involved in this process includes at least one curing phase in which the deposited liquid color agent must be transformed into a solid, permanent form. Thus, such traditional methods of producing color filters can be very time consuming. Traditional color filter production methods also require expensive materials and typically have a low yield, which further increases the cost of producing color filters. Also, as each color agent is processed by a separate line of equipment, equipment costs for such traditional methods are high. In fact, the cost of manufacturing the color filter of a LCD may be as much as 20% of the total cost of manufacturing the LCD.

Methods of using inkjet systems that allow the deposition of all three colors simultaneously and that reduce the cost of manufacturing color filters have been developed. An inkjet system may be used to deposit different colors through different nozzles into sub-pixels created by a patterned black matrix on a substrate.

The development of inkjet systems for manufacturing color filters of LCDs has created a need for inks that can be dispensed by an inkjet without clogging the inkjet, i.e., have good jettability, and that do not degrade during inkjetting. In particular, there is a need for inks that are physically and chemically stable before, during, and after inkjetting and that have a color chromaticity that meets color filter specifications for both computer and television monitors, as well as for other devices containing displays.

### SUMMARY OF THE INVENTION

The present invention provides compositions and methods for forming displays for flat panel devices. In one embodiment, a red ink for forming a display by an inkjet method comprises one or more red organic pigments, one or more monomers, one or more polymeric dispersants, and one or more organic solvents. The red ink may further comprise one or more yellow pigments.

In a further embodiment, the red ink comprises one or more red organic pigments, one or more yellow pigments, one or more monomers, one or more polymeric dispersants, one or more organic solvents, and one or more additives selected from the group consisting of a wetting agent, an adhesion promoter, a defoamer, an anti-skinning agent, and combinations thereof, wherein the ratio of the total wt % of the one or more red organic pigments to the total wt % of the one or more yellow organic pigments is between about 5:1 and about 2:1. The red ink may further comprise one or more oligomers.

In another embodiment, a method of forming a display is provided, the method comprising dispensing a red ink onto a substrate with an inkjet printing apparatus, wherein the red ink comprises one or more red organic pigments, one or more monomers, one or more polymeric dispersants, and one or more organic solvents. The red ink may also include one or more yellow pigments.

In a further embodiment, a display is provided, wherein the color filter is produced by a process comprising dispensing a red ink onto a substrate with an inkjet printing apparatus, wherein the red ink comprises one or more red organic pigments, one or more monomers, one or more polymeric dispersants, and one or more organic solvents. The red ink may also include one or more yellow pigments.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top view of two pixels each containing three sub-pixels according to the prior art.

FIG. 2 is a side, cross-sectional view of the pixels of FIG. 1 according to the prior art.

FIG. 3 is a perspective view of an exemplary inkjet printing apparatus that may be used according to embodiments of the invention.

### DETAILED DESCRIPTION

The present invention generally provides a red ink for a flat panel display. For example, the red ink may be used as part of a color filter for a LCD or to filter color in an organic-light emitting diode (OLED) display. A method of forming a color filter comprising dispensing the red ink on a substrate is also provided. The red ink is dispensed by an inkjet printing apparatus.

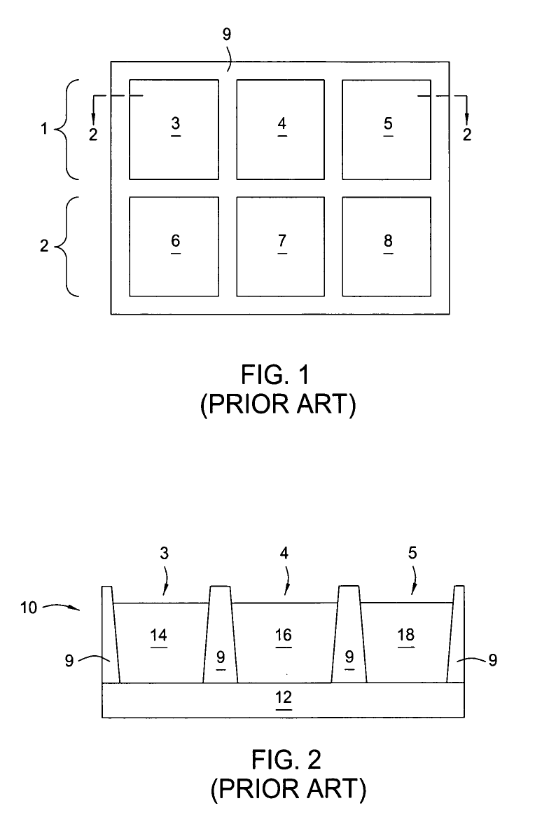

In one embodiment, the substrate on which the ink is dispensed, i.e., the substrate for the color filter, may be any material having a high degree of optical transparency, such as glass. The substrate has a patterned black matrix material thereon, as shown in FIGS. 1 and 2. The black matrix material may be, for example, a black matrix resin or a chromium oxide-based black matrix material that includes a photoresist. Optionally, the substrate may be pre-treated, such as with a surface active compound prior to the deposition of the ink on the substrate to enhance the spread of the ink on the substrate and to enhance the formation of a desired surface profile of the ink on the substrate.

In one embodiment, the red ink comprises one or more red organic pigments, one or more monomers, one or more polymeric dispersants, and one or more organic solvents. The red ink may include less than about 30 wt % of the one or more red organic pigments, e.g., between about 5 wt % and about 30 wt %, less than about 30 wt % of the one or more monomers, e.g., between about 5 wt % and about 30 wt %, between about 5 wt % and about 15 wt % of the one or more polymeric dispersants, and between about 40 wt % and about 70 wt % of the one or more organic solvents. Optionally, the red ink may also include one or more oligomers, such as less than about 15 wt % of the one or more oligomers, e.g., between about 1 wt % and about 15 wt % of the one or more oligomers. The red ink may also include one or more additives. The one or more additives may include a wetting agent, an adhesion promoter, a defoamer, an anti-skinning agent, or combinations thereof. The components of the red ink and the optional additives will be described in further detail below. The one or more red pigments, optional one or more oligomers, one or more polymeric dispersants and one or more solvents may be blended and milled at a high speed, such as between about 3000 rpm and about 7000 rpm by using a milling machine, such as a milling machine available from Hockmeyer Equipment Corporation (e.g., an H-2 Disperser, HVR Disperser or HV-HVI Disperser), to form a stable red nano-particle pigment dispersion. Then, the red pigment dispersion, the one or more monomers, and the optional additives may be blended together and ultra-sonicated, such as at 120 W for 40 s/100 ml, to form the red ink, which has a high pigment loading.

The one or more red organic pigments may be a PR 254 (pigment red number 254 according to the Color Index) pigment, e.g., Irgaphor Red BT-CF, a PR 177 (pigment red number 177 according to the Color Index) pigment, e.g., Fastogen Red ATY-TR, Fastogen Red ATY-01, Cromopophtal Red A2B, Cromopophtal Red A3B, or a combination thereof. The red organic pigments may have an average particle size of less than 200 nm, such as between about 20 nm and about 200 nm. The total pigment loading (the percent weight of the ink that is provided by the pigment) of the one or more red organic pigments is less than 30 wt %, such as between about 5 wt % and about 30 wt %.

Preferably, the ink also includes one or more yellow pigments in addition to the one or more red organic pigments at a total pigment loading of the one or more red organic pigments and the one or more yellow pigments of less than 30 wt %, such as between about 5 wt % and about 30 wt %. The pigment loading of the one or more yellow pigments may be between about 1 wt % and about 15 wt %, preferably between about 3 wt % and about 7 wt %. PY 138 and PY 139 are examples of yellow pigments that may be used. Examples of a PY 138 pigment are Paliotol Yellow L0960HD, Paliotol Yellow D0960, and Paliotol Yellow FD 4275. An example of a PY 139 pigment is Irgaphor Yellow 2R-CF. In one aspect, the ratio of the amount, i.e., total wt %, of red pigment(s) to the amount of yellow pigment(s) in the ink is between about 5:1 and about 2:1, preferably between about 4:1 and about 3:1.

It is believed that the combination of red and yellow pigments described herein results in the formation of red inks that have a desired chromaticity for color filters for TV and computer LCD monitors. Red inks having a chromaticity of x=0.6475, y=0.3190, and Y=17.50 to x=0.6615, y=0.3390, and Y=19.80. (wherein x and y are the color coordinates on a CIE chromaticity diagram and Y is a luminance measurement) were obtained according to embodiments of the invention using the combination of red and yellow pigments described herein.

The one or more monomers may be diacrylate esters or acrylic esters, such as 1,6-hexanediol diacrylate, propoxylated neopental glycol diacrylate (2 PO NPGDA), or dipentaerythritol hexacrylate (DPHA). 1,6-hexanediol diacrylate is available from Sartomer Chemical under the name SR238, and DPHA is available from Nippon Kayaku Co., Ltd. The one or more monomers may be a dipentaerythritol pentaacrylate, such as SR399LV (low viscosity) or SR399, available from Sartomer Chemical. The monomers may be mono-, bi-, or multi-functional.

The one or more oligomers may be aromatic monoacrylate oligomers, aliphatic diacrylate oligomers, aliphatic triacrylate oligomers, or polyester acrylate oligomers. An example of a polyester acrylate oligomer that may be used is CN2279 from Sartomer Chemical. The one or more monomers and the optional one or more oligomers polymerize upon the application of certain types of energy to provide a matrix within which the color pigments are dispersed.

The polymeric dispersants include a polymeric backbone having pigment anchoring groups attached thereto that stabilize the pigment(s) within the ink and minimize the aggregation and settling of the pigment(s). The polymeric dispersants can be polymeric amides, polyesters, polyacrylic acid polymers, acrylic acid/maleic acid copolymers, or combinations thereof. It is believed that the polymeric dispersants improve the color uniformity and physical uniformity of color filters by enhancing the uniform distribution of pigments within the ink. The one or more polymeric dispersants may include Solsperse 34750, Solsperse 5000, or Solsperse 22000, all of which are available from Lubrizol. The one or more polymeric dispersants may also include glycerol mono-oleate, which is available as Capmul® GMO-50 from Abitec Corporation. EFKA® 7496 is a block copolymer that may be used as the polymeric dispersant.

The one or more organic solvents solubilize the other components of the ink to provide a flowable ink that is capable of being dispensed by an inkjet printing apparatus, such as through an inkjet nozzle. The one or more organic solvents also adjust the viscosity and surface tension of the ink. Red ink according to embodiments of the invention may have a low viscosity, e.g., between about 5 cPs (centipoise) and about 25 cPs, preferably between about 8 cPs and about 20 cPs at 100 rpm and 20.0° C., as measured by a Brookfield DV-III+ Pro Viscometer. Red ink according to embodiments of the invention may have a surface tension of between about 22 mN/m and about 35 mN/m, preferably between about 24 mN/m and about 30 mN/m, at 20.0° C., as measured by an AquaPi tensiometer, a surface tension measurement tool available from Kibron, Inc. The one or more solvents may be acetates, such as methyl proxitol acetate (MPA), propylene glycol diacetate, butyl acetate, 3-methoxybutyl acetate, methoxy propanolacetate, or propyleneglycol monomethylether acetate, propionates, such as n-amyl propionate or ethyoxyethylpropionate, alcohols, such as butanol, or combinations thereof.

The optional wetting agent enhances the spread of the ink on the substrate. Examples of types of wetting agents that may be used include silicone polyether acrylates, polyamine amides, and polyesters. An example of a wetting agent that may be used is TEGO® Rad 2200 N. The ink may comprise between about 0 wt % and about 0.5 wt % of the wetting agent.

The optional adhesion promoter enhances the adhesion of the ink to the substrate. The adhesion promoter may be a trifunctional acrylate ester, such as SR9012, available from Sartomer, or a trifunctional methacrylate ester, such as SR9008, also available from Sartomer. Other adhesion promoters that may be used include organic titanates and zirconates. The ink may comprise between about 1 wt % and about 5 wt % of the adhesion promoter.

The optional defoamer minimizes the presence or formation of bubbles in the ink. The defoamer may also function as an anti-foaming agent. The defoamer may be a silicone defoamer, such as a defoamer containing foam destroying polymers and polysiloxanes. An example of a silicone defoamer that may be used is BYK®-088, available from BYK-Chemie. The ink may comprise between about 0.1 wt % and about 2.0 wt %, preferably between 0.3 wt % and about 1.0 wt %, of the defoamer.

The optional anti-skinning agent prevents the formation of a skin on the ink during storage or use. The anti-skinning agent may be an anti-oxidant, such as a phenolic or oximic anti-oxidant or an anti-oxidant that is free of phenols and oximes, such as Ascinin® Anti Skin VP 0443. The ink may comprise between about 0.3% wt % and about 15 wt % of the anti-skinning agent.

In addition to the components described above, the ink may include one or more curing agents, such as a thermal initiator or a photo-initiator. A thermal initiator may be included in inks that are thermally cured, and a photo-initiator may be included in inks that are photochemically cured, such as by ultraviolet light. A curing agent may not be required, depending on the method that is used to cure the ink. For example, an ink that is electron beam cured may not require a separate initiator.

The ink may include between about 0.1 wt % and about 10 wt % of one or more thermal initiators. Examples of thermal initiators that may be used include organic peroxides, such as Luperox® 101 and Luperox® DI, available from Arkema. Other types of thermal initiators that may be used include persulfates, peresters, percarbonates, and azo initiators.

The ink may include between about 0.1 wt % and about 10 wt % of one or more photo-initiators. Examples of photo-initiators that may be used include propanone or phenylbis initiators, e.g., phenylbis(2,4,6-trimethylbenzoyl)-phosphine oxide. Examples of propanone or phenylbis initiators that may be used include Irgacure® 1171, Irgacure® 1173, Irgacure® 379, and Irgacure® 879, all of which are available from Ciba.

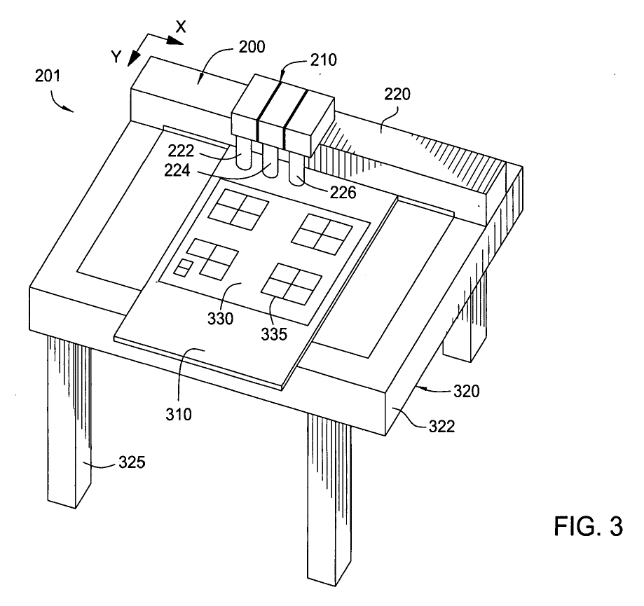

An example of an inkjet printing apparatus that may be used to deliver the red inks provided according to embodiments of the invention is described below with respect to FIG. 3.

FIG. 3 is a perspective view of an exemplary embodiment of an inkjet printing apparatus 201 to form color filters in flat panel displays of the present invention. FIG. 3 illustrates components of a stage positioning system 320 which includes a stage 310. In the embodiment shown in FIG. 3, the stage 310 moves in the Y direction and the inkjet heads 222, 224, and 226 of an inkjet printing module 210 move in the X direction. In other embodiments, the stage 310 could move in both X and Y directions. A stage moving device (not shown) with one or more motors could be used to move the stage 310 in the Y-axis direction. In an exemplary embodiment, the substrate stage 310 can also be rotatable by using an appropriate stage rotating device (not shown). The stage 310 can also be rotated so as to rotate and/or orient the substrate 330 for aligning the substrate 330 and the display object(s) contained thereon with an inkjet printing module 210 of a inkjet printing system 200, both of which are described below.

The stage 310 can be of any appropriate or suitable size to support a substrate or substrates which are to be processed. In an exemplary embodiment, the apparatus 201 and its component parts can, for example, process substrates having dimensions of, for example, 5500 cm² and above. The apparatus 201 and its component parts can be designed and adapted to process substrates having any size.

The apparatus 201 also include a stage positioning system 320 which supports the substrate stage 310 and which, in an exemplary embodiment, can include a top portion 322 and a plurality of legs 325. Each leg may include an air cylinder or other cushioning mechanism (not shown) to isolate the stage 310 from vibrations (e.g., from the floor on which the apparatus 201 rests). The stage positioning system 320 can also include a controller (not shown) for controlling the operation of the stage moving device (not shown). The substrate 330 shown in FIG. 3 can include any number of display objects 335.

FIG. 3 illustrates an inkjet printing module 210 of the inkjet printing system 200 and an inkjet printing module support 220 on which the inkjet printing module 210 is mounted. In an exemplary embodiment, the inkjet printing module 210 is moveable along the inkjet printing module support 220 by an inkjet positioning device (not shown). In the embodiment of FIG. 3, the inkjet printing module 210 includes three inkjet devices 222, 224 and 226. In an exemplary embodiment, each inkjet device 222, 224 and 226 can dispense a different color ink, for example red, green, blue, and optionally a clear ink, depending upon the color system being utilized. For example, a first inkjet device can dispense red ink, a second inkjet device can dispense green ink and a third inkjet device can dispense blue ink. In another exemplary embodiment, any one or more of the inkjet devices can dispense the same color ink or a clear ink. Although described as being equipped with three inkjets devices, the inkjet printing module 210 and the apparatus 201 of the present invention can utilize any number of inkjet devices depending upon the application or use of the apparatus 201.

In one embodiment of the invention, each of the inkjet devices 222, 224 and 226 can move independently of each other while printing. This may be advantageous when printing more than one panel on a substrate. Each of the inkjet devices 222, 224 and 226 can include an inkjet head (not shown), an isolated head interface board (not shown), a height adjustment device (not shown), a head rotation actuator device (not shown), and an ink reservoir (not shown). For example, each of the inkjet head, can be rotated by its respective head rotation actuator device. In this manner, the pitch or the angle at which an inkjet head is oriented relative to a display object on a substrate can be changed depending upon a printing application. Each inkjet head can have numerous nozzles.

The inkjet printing apparatus described above with respect to FIG. 3 is one example of an inkjet printing apparatus that may be used with embodiments of the invention. Another example of an inkjet printing apparatus that may be used is described in commonly assigned U.S. patent application Ser. No. 11/019,967 (APPM 9521), filed Dec. 22, 2004 and entitled “Apparatus and Methods for an Inkjet Head Support having an Inkjet Head Capable of Independent Lateral Movement,” which is incorporated by reference herein.

After the red ink is delivered onto the substrate by the inkjet printing apparatus, the red ink is typically cured. In one embodiment, the red ink further comprises a thermal initiator and is cured by heating the substrate at between about 120° C. and about 250° C. in a baking chamber for about 5 minutes to about 20 minutes. In another embodiment, the red ink comprises a photo-initiator and is cured by exposing the substrate to UV radiation having a wavelength between about 254 nm and about 360 nm with a scanning speed between about 5 feet/min to about 25 feet/min.

The red inks provided according to embodiments of the invention for producing displays by inkjetting are physically and chemically stable during inkjetting and can be stored at ambient conditions. The red inks have a color chromaticity and a high color transparency that are desirable for both computer and television displays.

While the red inks provided herein have been described primarily with respect to color filters for LCDs, the red inks provided herein may also be used for organic light-emitting diode (OLED) displays. For example, the red inks may be used to filter color in an OLED display that contains white light-emitting diodes.

The following non-limiting examples are provided to further illustrate the embodiments of the invention. However, the examples are not intended to be all inclusive and is not intended to limit the scope of the invention described herein.

### EXAMPLE 1

A red ink for a color filter of a flat panel display was formed by mixing the following ingredients to form an ink having the following wt % of the ingredients: 4.0% SR238 (monomer), 2.5% SR9008 (adhesion promoter), 2.5% SR399LV (monomer), 0.25% TEGO® Rad 2200 N (wetting agent), 0.50% BYK-088 (defoamer), 5.0% Ascinin® Anti Skin VP 0443 (anti-skinning agent), 10.1 wt % Irgaphor Red BT-CF (PR 254), 5.17 wt % Fastogen Red ATY-TR (PR 177), 6.05 wt % Irgaphor Yellow 2R-CF (PY 139), 29.3% n-amyl propionate (solvent), 6.84% MPA (solvent), 2.28% propyleneglycol diacetate (solvent), 21.3% EFKA® 7496 (35% active ingredient, polymeric dispersant), 0.93% Solsperse 22000 (polymeric dispersant), 3.25% CN2279 (oligomer). The red ink was delivered to a substrate for a flat panel display using an inkjet printing apparatus. The red ink was then cured by an electron beam curing system. The red ink had a chromaticity as follows: x=0.6507, y=0.3299 and Y=18.907, as measured by a spectrophotomer

### EXAMPLE 2

A red ink for a color filter of a flat panel display was formed by mixing the following ingredients: 2.9 wt % Irgacure® 1171 (photo-initiator), 0.34 wt % Irgacure® 379 (photo-initiator), 3.4 wt % SR238 (monomer), 3.40 wt % DPHA (monomer), 1.6 wt % Capmule GMO-50 (polymeric dispersant), 6.1 wt % Irgaphor Red BT-CF (PR 254), 3.3 wt % Fastogen Red ATY-TR (PR 177), 2.9 wt % Irgaphor Yellow 2R-CF (PY 139), 0.12 wt % TEGO® Rad 2200 N (wetting agent), 0.4 wt % BYK-088 (defoamer), 1.6 wt % SR9008 (adhesion promoter), 48.9 wt % MPA (solvent), 16.3 wt % propyleneglycol diacetate (solvent), 8.3 wt % Solsperse 34750 (polymeric dispersant), and 0.46 wt % Solsperse 22000 (polymeric dispersant). The red ink was delivered to a substrate for a flat panel display using an inkjet printing apparatus. The red ink was then cured by a UV irradiation system. The red ink had a chromaticity as follows: x=0.6507, y=0.3303 and Y=19.09, as measured by a spectrophotomer

While the foregoing is directed to embodiments of the present invention, other and further embodiments of the invention may be devised without departing from the basic scope thereof, and the scope thereof is determined by the claims that follow.

What is claimed is:

1. A red ink comprising:
one or more red organic pigments;
one or more monomers;
one or more polymeric dispersants; and
one or more organic solvents.

2. The red ink of claim 1, further comprising one or more yellow pigments.

3. The red ink of claim 2, wherein the red ink has a viscosity of between about 5 cPs and about 25 cPs at 20° C. and a surface tension between about 22 mN/m and about 35 mN/m at 20° C.

4. The red ink of claim 1, further comprising one or more oligomers.

5. The red ink of claim 4, wherein the one or more oligomers are selected from the group consisting of aromatic monoacrylate oligomers, aliphatic diacrylate oligomers, aliphatic triacrylate oligomers, polyester acrylates, and combinations thereof.

6. The red ink of claim 1, further comprising a wetting agent, an adhesion promoter, a defoamer, or an anti-skinning agent.

7. The red ink of claim 1, wherein the red ink has a chromaticity of between x=0.6475, y=0.3190, and Y=17.50 to x=0.6615, y=0.3390, and Y=19.80.

8. The red ink of claim 1, wherein the one or more red organic pigments are selected from the group consisting of PR 254 pigments, PR 177 pigments, and combinations thereof, the one or more monomers are selected from the group consisting of diacrylate esters, acrylic esters, dipentaerythritol pentaacrylates and combinations thereof, the one or more polymeric dispersants are selected from the group consisting of polymeric amides, polyesters, polyacrylic acid polymers, acrylic acid/maleic acid copolymers, and combinations thereof, and the one or more organic solvents are selected from the group consisting of acetates, propionates, alcohols, and combinations thereof.

9. The red ink of claim 8, further comprising a wetting agent selected from the group consisting of silicone polyether acrylates, polyamine amides, and polyesters, an adhesion promoter selected from the group consisting of trifunctional acrylate esters, trifunctional methacrylate esters, organic titanates, and zirconates, a silicone defoamer, and an anti-skinning agent selected from the group consisting of phenolic anti-oxidants, oximic anti-oxidants, anti-oxidants that are free of phenols and oximes, and combinations thereof.

10. A red ink comprising:
one or more red organic pigments;
one or more yellow pigments, wherein the ratio of the total wt % of the one or more red organic pigments to the total wt % of the one or more yellow organic pigments is between about 5:1 and about 2:1;
one or more monomers;
one or more polymeric dispersants;
one or more organic solvents; and
one or more additives selected from the group consisting of a wetting agent, an adhesion promoter, a defoamer, an anti-skinning agent, and combinations thereof.

11. The red ink of claim 10, wherein the total wt % of the one or more red organic pigments and the one or more yellow pigments is between about 5 wt % and about 30 wt %, and the red ink comprises between about 5 wt % and about 30 wt % of the one or more monomers, between about 5 wt % and about 15 wt % of the one or more polymeric dispersants, and between about 40 wt % and about 70 wt % of the one or more organic solvents.

12. The red ink of claim 11, wherein the red ink further comprises between about 1 wt % and about 15 wt % of one or more oligomers.

13. The red ink of claim 10, wherein the red ink comprises about 15.27 wt % red organic pigments, about 6.05 wt % yellow pigments, about 6.5 wt % monomers, about 3.25 wt % oligomers, about 7.5 wt % polymeric dispersants, about 38.42 wt % organic solvents, about 0.25 wt % wetting agent, about 2.5 wt % adhesion promoter, about 3 wt % anti-skinning agent, and about 0.5 wt % defoamer.

14. A method of forming a display, comprising:
dispensing a red ink onto a substrate with an inkjet printing apparatus, wherein the red ink comprises:
one or more red organic pigments;
one or more monomers;
one or more polymeric dispersants; and
one or more organic solvents.

15. The method of claim 14, wherein the red ink further comprises one or more yellow pigments.

16. The method of claim 15, wherein the ratio of the total wt % of the one or more red organic pigments to the total wt % of the one or more yellow organic pigments is between about 5:1 and about 2:1, and the red ink further comprises one or more additives selected from the group consisting of a wetting agent, an adhesion promoter, a defoamer, an anti-skinning agent, and combinations thereof.

17. The method of claim 14, wherein the one or more red organic pigments are selected from the group consisting of PR 254 pigments, PR 177 pigments, and combinations thereof, the one or more monomers are selected from the group consisting of diacrylate esters, acrylic esters, dipentaerythritol pentaacrylates and combinations thereof, the one or more polymeric dispersants are selected from the group consisting of polymeric amides, polyesters, polyacrylic acid polymers, acrylic acid/maleic acid copolymers, and combinations thereof, and the one or more organic solvents are selected from the group consisting of acetates, propionates, alcohols, and combinations thereof.

18. The method of claim 17, wherein the red ink further comprises one or more oligomers selected from the group consisting of aromatic monoacrylate oligomers, aliphatic diacrylate oligomers, aliphatic triacrylate oligomers, polyester acrylates, and combinations thereof, a wetting agent selected from the group consisting of silicone polyether acrylates, polyamine amides, and polyesters, an adhesion promoter selected from the group consisting of trifunctional acrylate esters, trifunctional methacrylate esters, organic titanates, and zirconates, a silicone defoamer, and an anti-skinning agent selected from the group consisting of phenolic anti-oxidants, oximic anti-oxidants, oxidants that are free of phenols and oximes, and combinations thereof.

19. The method of claim 14, wherein the red ink comprises about 15.27 wt % red organic pigments, about 6.05 wt % yellow pigments, about 6.5 wt % monomers, about 3.25 wt % oligomers, about 7.5 wt % polymeric dispersants, about 38.42 wt % organic solvents, about 0.25 wt % wetting agent, about 2.5 wt % adhesion promoter, about 3 wt % anti-skinning agent, and about 0.5 wt % defoamer.

20. The method of claim 14, further comprising curing the red ink after it is dispensed onto the substrate.

21. A display, produced by a process comprising:
dispensing a red ink onto a substrate with an inkjet printing apparatus, wherein the red ink comprises:
one or more red organic pigments;
one or more monomers;
one or more polymeric dispersants; and
one or more organic solvents.

22. The display of claim 21, wherein the red ink further comprises one or more yellow pigments.

23. The display of claim 22, wherein the ratio of the total wt % of the one or more red organic pigments to the total wt % of the one or more yellow organic pigments is between about 5:1 and about 2:1, and the red ink further comprises one or more oligomers and one or more additives selected from the group consisting of a wetting agent, an adhesion promoter, a defoamer, an anti-skinning agent, and combinations thereof.
